(19) United States
(12) Patent Application Publication
(10) Pub. No.: US 2012/0050178 A1
(43) Pub. Date: Mar. 1, 2012

(54) Touch-Sensitive Display Module

(76) Inventor: Ke-Feng Lin, Taipei (TW)

(21) Appl. No.: 12/873,326

(22) Filed: Sep. 1, 2010

(51) Int. Cl. G06F 3/041

(52) U.S. Cl. 345/173

(57) ABSTRACT

A touch-sensitive display apparatus includes a touch-sensitive panel, a display module attached under the touch-sensitive panel, a frame wrapping the touch-sensitive panel and the display module. A lateral side of the display module is recessed to form a buckling recess. A lateral side of the frame is protruded toward the display module to form a bar corresponding to the buckling recess. The touch-sensitive panel and the display module are fixed in the frame by means of the bar buckling into the buckling recess instead of attaching the touch-sensitive panel on a top of the protrusion by an adhesive tape. So, the size of the protruding portion is reduced sharply. Therefore, the display module can be bigger when the dimension of the touch-sensitive apparatus remains the same.

### BACKGROUND OF THE INVENTION

1. Field of the Invention

The present invention relates to a touch-sensitive display apparatus, and particularly to a touch-sensitive display apparatus capable of accommodating a larger display module.

2. The Related Art

With the development of the electrical industry, the consumer electronics are becoming popular in our daily life, especially the product combining touch-input and display technology. As the product with touch screen and display device enriches the user experience greatly, it has been applied widely. Meanwhile, the product is becoming smaller and thinner, it brings forward higher request of the size of the display module.

FIGS. 6-7 show a conventional touch-sensitive display apparatus 30. The touch-sensitive display apparatus 30 includes a display module 330, a touch-sensitive panel 320 attached on the display module 330, a frame 310 wrapping the touch-sensitive panel 320 and the display module 330. The frame 310 has a lower portion protruded to form a protruding portion 311. Two opposite sides of the touch-sensitive panel 320 are extended beyond the display module 330 to form stickling portions 321 attached on a top of the protruding portion 311 by an adhesive tape 340, so as to fix the touch-sensitive panel 320 and the display module 330 in the frame 310. However, it requires that the area of the top of the protruding portion 311 should be large enough in order to attach the touch-sensitive panel 320 firmly in the frame 310. As a result, the dimension of the display module 330 is much smaller than that of the touch-sensitive panel 320, which limits the size of the display module 330.

### SUMMARY OF THE INVENTION

Accordingly, an object of the present invention is to provide a touch-sensitive display apparatus. The touch-sensitive display apparatus includes a touch-sensitive panel, a display module attached under the touch-sensitive panel, a frame wrapping the touch-sensitive panel and the display module. A lateral side of the display module is recessed to form a buckling recess. A lateral side of the frame is protruded toward the display module to form a bar buckling with the buckling recess for fixing the touch-sensitive panel and the display module into the frame.

As described above, the frame has a bar mating with the buckling recess recessed in the display module. The touch-sensitive panel and the display module are fixed in the frame by means of the bar buckling into the buckling recess instead of attaching the touch-sensitive panel on a top of the protrusion by an adhesive tape. So, the size of the protruding portion can be reduced sharply, even, the protruding portion can be canceled. Therefore, the dimension of the touch-sensitive apparatus can be smaller when the size of the display module remains the same. In another word, the display module can be bigger when the dimension of the touch-sensitive apparatus remains the same.

### BRIEF DESCRIPTION OF THE DRAWINGS

The present invention will be apparent to those skilled in the art by reading the following description thereof, with reference to the attached drawings, in which:

FIG. 1 is an assembled, cross-sectional view of a touch-sensitive display apparatus of a first embodiment in accordance with the present invention;

FIG. 2 is a partly enlarged view showing an enlarged A portion of FIG. 1;

FIG. 3 is cross-sectional view showing an assembly process of the touch-sensitive display apparatus of FIG. 1;

FIG. 4 is an assembled, cross-sectional view of a touch-sensitive display apparatus of a second embodiment in accordance with the present invention;

FIG. 5 is a partly enlarged view showing an enlarged B portion of FIG. 4;

FIG. 6 is an assembled, cross-sectional view of a conventional touch-sensitive display apparatus; and

FIG. 7 is a partly enlarged view showing an enlarged C portion of FIG. 6.

### DETAILED DESCRIPTION OF THE EMBODIMENT

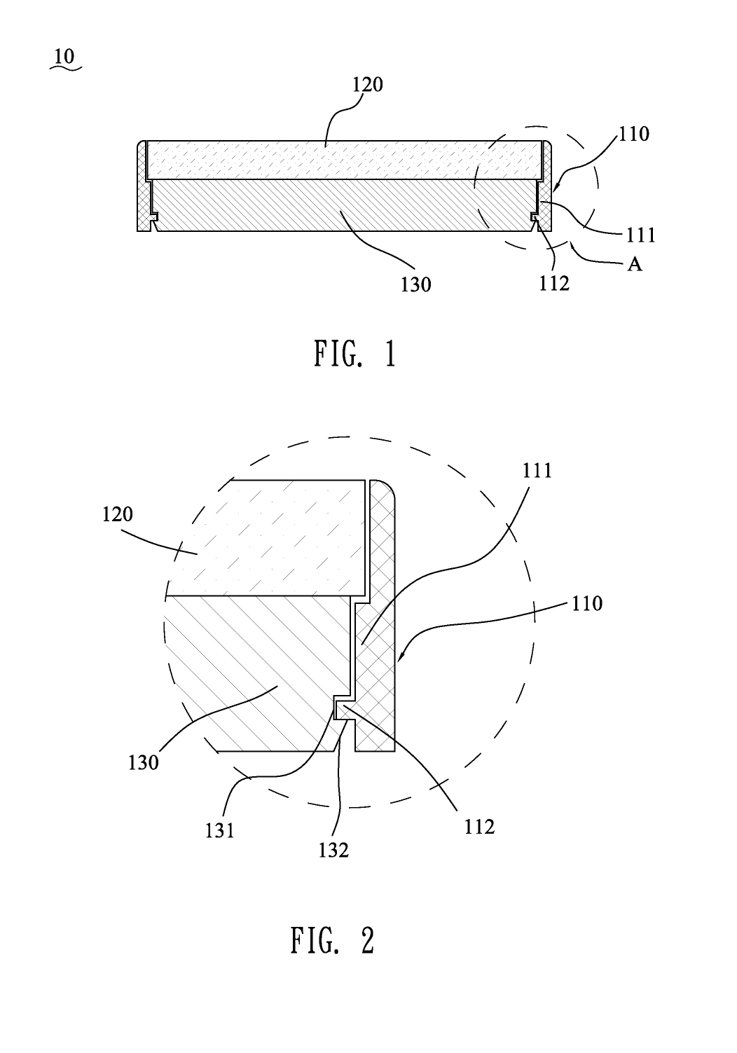

Referring to the drawings in greater detail, and first to FIG. 1, the first embodiment of the invention is embodied in a touch-sensitive display apparatus 10. The touch-sensitive display apparatus 10 includes a display module 130, a touch-sensitive panel 120 attached on the display module 130, a frame 110 wrapping the touch-sensitive panel 120 and the display module 130.

With reference to FIGS. 1-2, the display module 130 has an outer peripheral dimension smaller than that of the touch-sensitive panel 120. Two opposite lateral sides of the display module 130 are recessed to form buckling recesses 131 extending along a front-to-rear direction. A lower portion of each lateral side of the display module 130 is slanted inwardly to a bottom of the display module 130 to form an inclined surface 132. A top side of the inclined surface 132 communicates with the buckling recess 131. A lower portion of an inner side of the frame 110 is protruded toward the display module 130 to form a protruding portion 111. An inner side of the protruding portion 111 is protruded toward the display module 130 to form a bar 112 corresponding to the buckling recess 131.

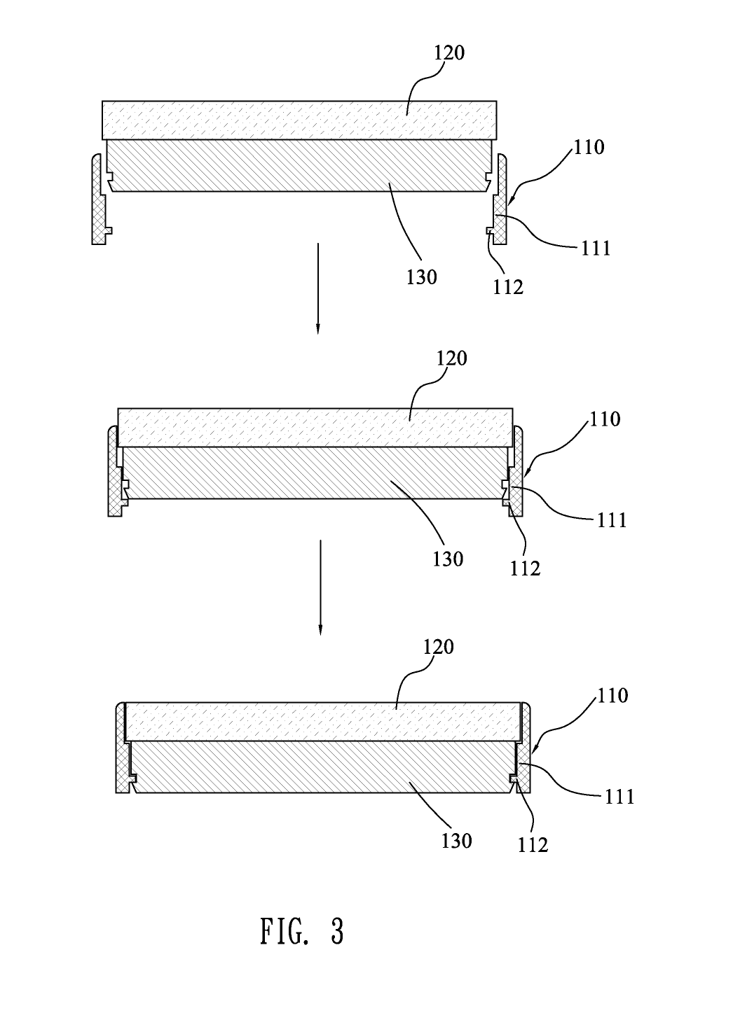

Please refer to FIGS. 2-3, while the touch-sensitive panel 120 and the display module 130 is assembled into the frame 110 from a top side of the frame 110, the bar 112 touches the inclined surface 132 first. Guided by the inclined surface 132, the bar 112 moves smoothly into the buckling recess 131 for fixing the touch-sensitive panel 120 and the display module 130 into the frame 110. The inclined surface 132 is capable of reducing the force applied on the bar 112, therefore, avoiding the bar 112 being broken when the bar 112 is pushed into the buckling recess 131.

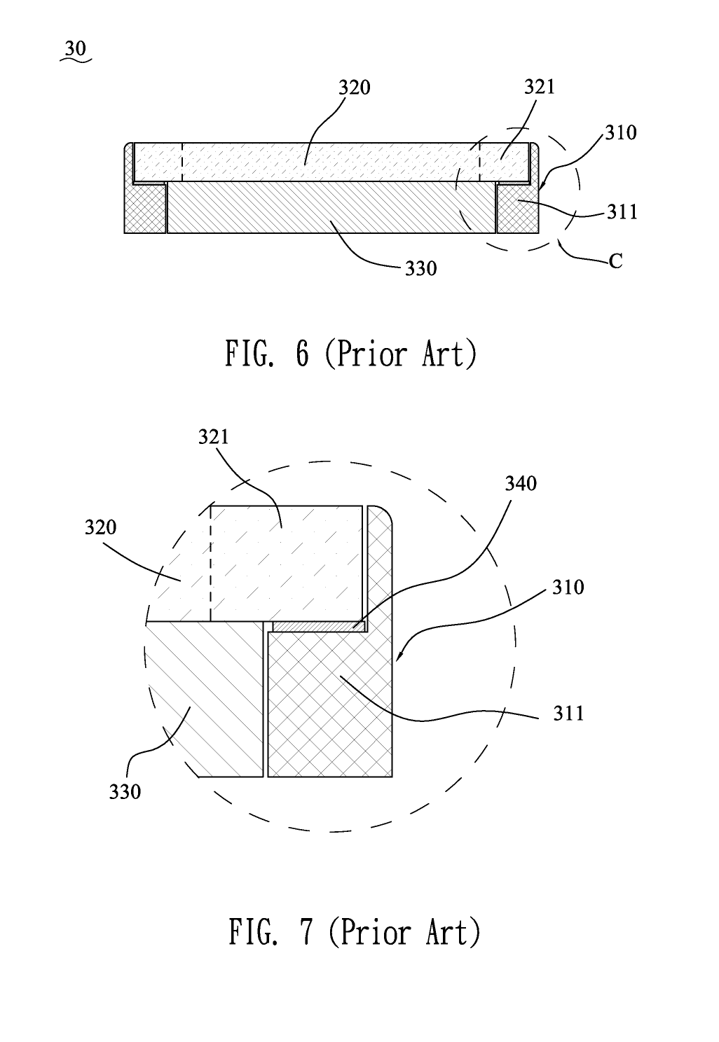

Referring to FIG. 1 and FIG. 6, the area of a top of the protruding portion 111 is becoming smaller due to the new design. On condition that the dimension of the display module 130 is the same, the frame 110 can be smaller than the original design, so the dimension of the product can be smaller. In another word, on condition that the dimension of the frame 110 is the same, the display module 130 can be much bigger than the original design.

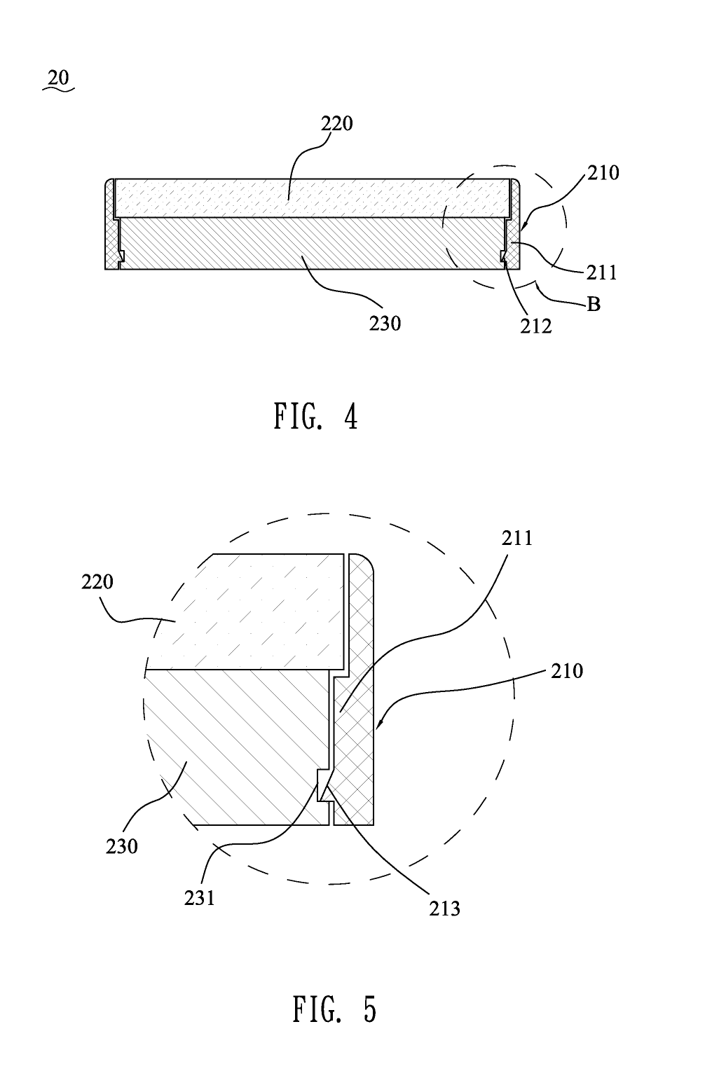

Referring to FIG. 4, the second embodiment of the invention is embodied in a touch-sensitive display apparatus 20. The touch-sensitive display apparatus 20 includes a display module 230, a touch-sensitive panel 220 fixed on the display module 230, a frame 210 wrapping the touch-sensitive panel 220 and the display module 230.

With reference to FIGS. 4-5, the display module 230 has an outer peripheral dimension smaller than that of the touch-sensitive panel 220. Two opposite sides of the display module 230 are recessed to form buckling recesses 231 extending along a front-to-rear direction. A lower portion of the frame 210 is protruded toward the display module 230 to form a protruding portion 211. An inner side of the protruding portion 211 is protruded outward to form a bar 212 for mating with the buckling recess 231. The bar 212 has an inclined side surface 213 to guide the display module 230 mounted into the frame 210 and reducing the force applied on the bar 212 during the process.

As described above, the frame 110 has a bar 112 mating with the buckling recess 131 recessed on a lateral side of the display module 130. The touch-sensitive panel 120 and the display module 130 are fixed in the frame 110 by means of the bar 112 buckling into the buckling recess 131 instead of attaching the touch-sensitive panel 120 on a top of the protrusion 111 by an adhesive tape. So, the size of the protruding portion 111 is reduced. Therefore, the dimension of the touch-sensitive apparatus 10 can be smaller when the size of the display module 130 remains the same. In another word, the display module 130 can be bigger when the dimension of the touch-sensitive apparatus 10 remains the same.

What is claimed is:

1. A touch-sensitive display apparatus, comprising:
a touch-sensitive panel;
a display module attached under the touch-sensitive panel, a lateral side of the display module recessed to form a buckling recess; and
a frame wrapping the touch-sensitive panel and the display module, an inner side of the frame protruded toward the display module to form a bar buckling with the buckling recess for fixing the touch-sensitive panel and the display module in the frame.

2. The touch-sensitive display apparatus as claimed in claim 1, wherein a lower portion of the lateral side of the display module is slanted inwardly to a bottom of the display module to form an inclined surface, for guiding the bar into the buckling recess.

3. The touch-sensitive display apparatus as claimed in claim 1, wherein a lateral side of the bar is slanted to form an inclined side surface facing the display module, for guiding the bar into the buckling recess.

4. The touch-sensitive display apparatus as claimed in claim 1, wherein a lower portion of the frame is protruded toward the display module to form a protruding portion, the bar is protruded at an inner side of the protruding portion.
